(19) United States
(12) Patent Application Publication
(10) Pub. No.: US 2016/0023293 A1
(43) Pub. Date: Jan. 28, 2016

(54) PANEL JOINING STRUCTURE FOR A VEHICLE

(71) Applicant: TOYOTA JIDOSHA KABUSHIKI KAISHA, Toyota-shi (JP)

(72) Inventor: Hiroyuki KUROKAWA, Nisshin-shi (JP)

(73) Assignee: TOYOTA JIDOSHA KABUSHIKI KAISHA, Toyota-shi (JP)

(21) Appl. No.: 14/798,995

(22) Filed: Jul. 14, 2015

(30) Foreign Application Priority Data
Jul. 25, 2014 (JP) 2014-152115

(51) Int. Cl. B23K 1/00; B62D 27/02; B62D 25/06

(52) U.S. Cl. CPC B23K 1/0008; B62D 25/06; B62D 27/02

(57) ABSTRACT

A panel joining structure for a vehicle includes a first plate, a second plate, a braze and a surface area enlargement portion. The first plate is formed of a metal and a first joining portion is formed thereat. The second plate is formed of a different metal from the first plate and a second joining portion that is to be joined with the first joining portion is formed thereat. The braze is interposed between the first joining portion and the second joining portion. The braze joins the first joining portion with the second joining portion. The surface area enlargement portion is formed in a range that makes contact with the braze at, of the first joining portion and the second joining portion, a side at which the braze and a heterogenous metal are disposed. At least one of protrusions and recesses are formed at the surface area enlargement portion.

### CROSS-REFERENCE TO RELATED APPLICATION

This application claims priority under 35 USC 119 from Japanese Patent Application No. 2014-152115 filed Jul. 25, 2014, the disclosure of which is incorporated by reference herein.

### BACKGROUND

1. Technical Field

The present invention relates to a panel joining structure for a vehicle, and particularly relates to a panel joining structure for a vehicle in which the joining is implemented by brazing.

2. Related Art

Heretofore, a roof structure for a vehicle has been proposed in which a mohican portion is not provided at a region of joining between a roof panel of the vehicle and a roof side rail of the vehicle. For example, Japanese Patent Application Laid-Open (JP-A) No. 2004-131062 discloses a structure in which a joining surface of a roof panel and a joining surface of a body panel (a roof rail) are joined by an adhesive material and the adhesive material is covered with a sealant material. Further, in JP-A No. 2005-161909, a roof panel and a roof side rail are joined by laser brazing (brazing).

However, with the joining disclosed in JP-A No. 2004-131062, because the join is based on adhesive, it is difficult to assure joining strength. In a case of brazing joining as in JP-A No. 2005-161909, if the roof panel and the roof side rail are formed of different metallic materials, then at least one of the roof panel and the roof side rail is a metallic material that is heterogenous from the braze. In this case, intermetallic compounds may be produced at the welding interface. As a result, the joining strength between the braze and the heterogenous material may be weak and it may be difficult to assure joining strength between the roof panel and the roof side rail.

### SUMMARY

In consideration of the situation described above, the present invention provides a panel joining structure for a vehicle that may assure joining strength when two vehicle panels formed of different metallic materials are joined by brazing.

A panel joining structure for a vehicle according to a first aspect of the present invention includes: a first plate that is formed of a metal, at which a first joining portion is formed; a second plate that is formed of a different metal from the first plate, a second joining portion that is to be joined with the first joining portion being formed at the second plate; a braze that is interposed between the first joining portion and the second joining portion, the braze joining the first joining portion with the second joining portion; and a surface area enlargement portion in a range that makes contact with the braze at, of the first joining portion and the second joining portion, a side at which the braze and a heterogenous metal are disposed, at least one of protrusions and recesses being formed at the surface area enlargement portion.

In the first aspect of the present invention, the first joining portion of the first plate and the second joining portion of the second plate are joined via the braze. At least one of the first plate and the second plate is formed of a metal of a kind that is different from the braze (the heterogenous metal). However, the surface area enlargement portion at which one or both of protrusions and recesses are formed is provided in the range that makes contact with the braze at, of the first joining portion and the second joining portion, each side at which the braze and a heterogenous metal are disposed (the first plate, the second plate, or both the first plate and the second plate).

According to the first aspect of the present invention, a mutual joining area between the plate of the heterogenous metal and the braze is enlarged by the surface area enlargement portion being formed in the range that makes contact with the braze at, of the first joining portion and the second joining portion, the side at which the braze and the heterogenous metal are disposed. That is, because the surface area enlargement portion is formed, the joining area with the braze is enlarged, as a result of which a joining strength between the first plate and the second plate may be assured.

In a panel joining structure for a vehicle according to a second aspect of the present invention, unevenness is formed at the surface area enlargement portion by a shelf portion that is formed in a step shape.

According to the second aspect of the present invention, the unevenness is formed by the shelf portion that is formed in the step shape, and the mutual joining area between the plate of the heterogenous metal and the braze may be enlarged with ease.

In a panel joining structure for a vehicle according to a third aspect of the present invention, second unevennesses are formed at a surface of the shelf portion that makes contact with the braze.

According to the third aspect of the present invention, because the second unevennesses are additionally formed at the shelf portion, the surface area of the surface area enlargement portion is further enlarged, and the mutual joining area between the plate of the heterogenous metal and the braze may be enlarged.

In a panel joining structure for a vehicle according to a fourth aspect of the present invention, the first plate is a steel plate and the second plate is an aluminium plate.

According to the fourth aspect of the present invention, in a case in which an aluminium plate is employed in order to reduce weight and used together with a steel plate in order to assure strength, the joining strength of the two plates in joining by brazing may be assured. That is, a joining strength per unit of area of the second joining portion, of the steel plate or the aluminium plate, with the braze may be increased. Thus, the joining strength of the first plate with the second plate may be assured.

A panel joining structure for a vehicle according to a fifth aspect of the present invention further includes: a seal shelf portion structured by a portion of one of the first plate or the second plate, the seal shelf portion extending from the first joining portion or the second joining portion in line with an outer surface of the braze; and a sealing material layer that is layered onto the braze and an outer side of the seal shelf portion, the sealing material layer being layered between the first joining portion and the second joining portion.

According to the fifth aspect of the present invention, because the seal shelf portion is formed in line with the outer surface of the braze, the sealing material layer that is layered onto the braze may also be formed at the outer side of the seal shelf portion. Although irregularities tend to occur at the outer surface of a braze, because the seal shelf portion is employed, thickness of the sealing material layer may be easily controlled, and the sealing material layer at the outer surface may easily be formed with a suitable thickness.

### BRIEF DESCRIPTION OF THE DRAWINGS

Exemplary Embodiments of the present invention will be described in detail based on the following figures, wherein:

FIG. 1 is a perspective view showing an upper portion of a vehicle roof in accordance with a first exemplary embodiment of the present invention.

FIG. 2 is a vertical sectional diagram of the vehicle roof taken along line A-A of FIG. 1.

FIG. 3 is a partial magnified view of FIG. 2.

FIG. 4 is a partial magnified view of a vertical section of a vehicle roof in accordance with a variant example of the first exemplary embodiment.

FIG. 5 is a partial magnified view of a vertical section of a vehicle roof in accordance with an alternative variant example of the first exemplary embodiment.

FIG. 6 is a partial magnified view of a vertical section of a vehicle roof in accordance with a second exemplary embodiment.

FIG. 7 is a partial magnified view of a vertical section of a vehicle roof in accordance with a third exemplary embodiment.

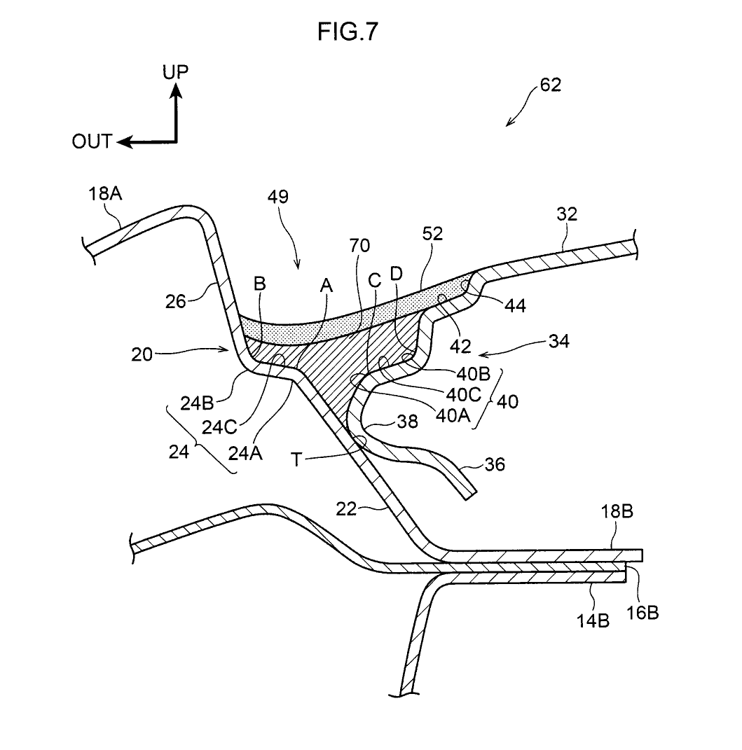

### DETAILED DESCRIPTION

### First Exemplary Embodiment

Herebelow, a first exemplary embodiment of a panel joining structure for a vehicle according to the present invention is described using the attached drawings. In the present exemplary embodiment, the panel joining structure for a vehicle is described using an example in which the panel joining structure for a vehicle is applied to a vehicle roof 10.

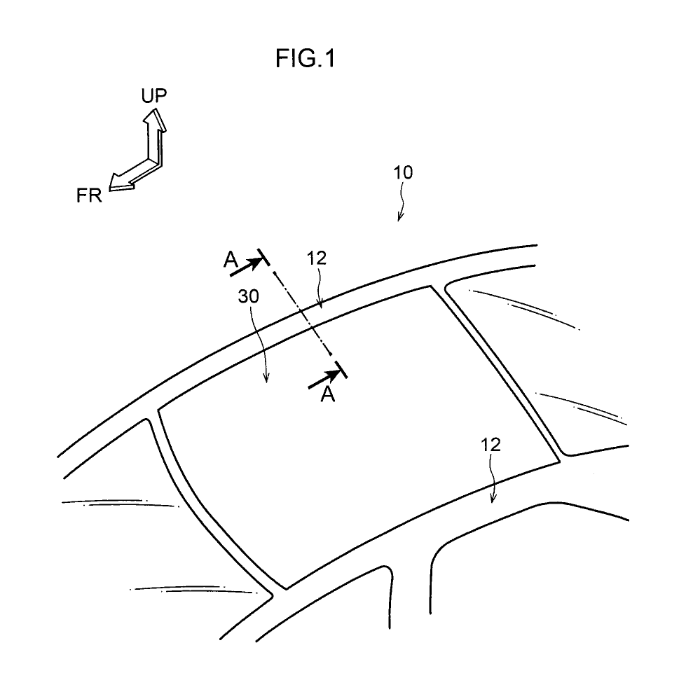

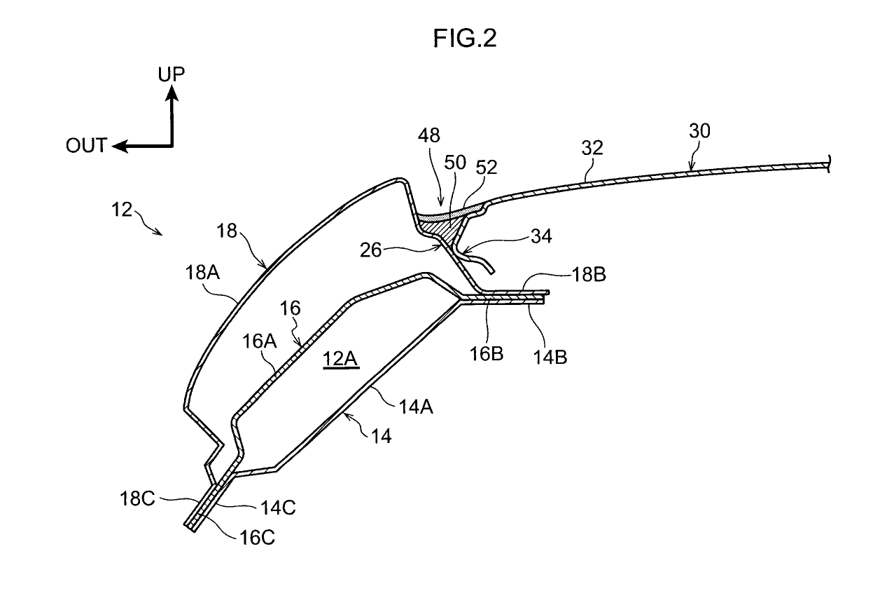

In FIG. 1, an upper portion of the vehicle roof 10 according to the first exemplary embodiment is shown in a perspective view. FIG. 2 shows a sectional diagram taken along line A-A of FIG. 1. An arrow UP that is shown in the drawings indicates a vehicle upward side, an arrow OUT indicates a vehicle width direction outer side, and an arrow FR indicates a vehicle forward side.

As shown in FIG. 1, the vehicle roof 10 includes a roof panel 30 and roof side rail portions 12. The roof panel 30 serves as a second plate and covers a cabin. The roof side rail portions 12 are provided at each of two vehicle width direction sides. An outer shell of the vehicle is structured with the roof panel 30. The roof side rail portions 12 are arranged along the vehicle front and rear direction as a pair at left and right.

As shown in FIG. 2, each roof side rail portion 12 is structured with three panels: a rail inner panel 14, a rail outer reinforcement 16 and a side outer panel 18 that serves as a first plate. The rail inner panel 14 is disposed at a vehicle cabin inner side and the rail outer reinforcement 16 is disposed at the vehicle cabin outer side relative to the rail inner panel 14. A closed cross section is formed by the rail inner panel 14 and the rail outer reinforcement 16. The side outer panel 18 is disposed at the vehicle cabin outer side of the rail outer reinforcement 16. The rail inner panel 14, the rail outer reinforcement 16 and the side outer panel 18 are all fabricated of steel plate.

The rail inner panel 14 is structured by a main body portion 14A, an inner side flange portion 14B and an outer side flange portion 14C. The main body portion 14A forms a closed cross section with the rail outer reinforcement 16. The inner side flange portion 14B is inflected substantially horizontally to the vehicle width direction inner side from an inner end portion of the main body portion 14A. The outer side flange portion 14C is inflected diagonally downward and outward from an outer end portion of the main body portion 14A.

The rail outer reinforcement 16 is formed with a hat-shaped cross section that is somewhat opened out. The rail outer reinforcement 16 is structured by a main body portion 16A, an inner side flange portion 16B and an outer side flange portion 16C. The main body portion 16A is disposed so as to oppose the main body portion 14A. The inner side flange portion 16B is inflected substantially horizontally to the vehicle width direction inner side from an inner end portion of the main body portion 16A. The outer side flange portion 16C is inflected diagonally downward and outward from an outer end portion of the main body portion 16A.

The side outer panel 18 is structured by a main body portion 18A, an inner side flange portion 18B and an outer side flange portion 18C. The main body portion 18A is in a protruding shape capable of covering the main body portion 16A of the rail outer reinforcement 16 from the vehicle cabin outer side thereof. The inner side flange portion 18B is inflected substantially horizontally to the vehicle width direction inner side from an inner end portion of the main body portion 18A. The outer side flange portion 18C is inflected diagonally downward and outward from an outer end portion of the main body portion 18A.

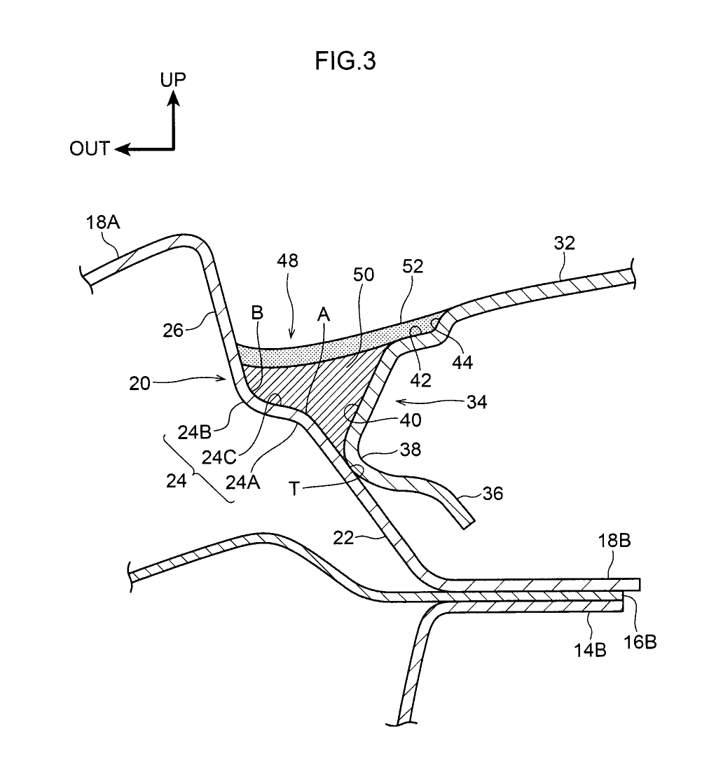

As shown in FIG. 3, a diagonal wall 20 is formed at the vehicle width direction inner side of the main body portion 18A. The diagonal wall 20 is inflected and rises diagonally upward to the vehicle outer side from an outer side end portion of the inner side flange portion 18B. The diagonal wall 20 is structured with an inner side portion 22, a first joining portion 24 and an outer side portion 26. The inner side portion 22 refers to a region from an end portion of the diagonal wall 20 at the side at which the inner side flange portion 18B is disposed to a contact point T at which the diagonal wall 20 makes contact with an inflected end portion 34 of the roof panel 30, which is described below. The first joining portion 24 refers to a region that is brazed with a braze 50, which is described below, from the contact point T to a region corresponding with an upper end of the braze 50. The outer side portion 26 refers to a region from the region corresponding with the upper end of the braze 50 to the upper end of the diagonal wall 20.

A first protrusion portion 24A and a first recess portion 24B are formed at the first joining portion 24. The first protrusion portion 24A is curved to the vehicle outer side so as to form a protrusion, and the first recess portion 24B is curved such that the vehicle outer side is recessed. A first shelf portion 24C is formed between a ridge line A of a peak portion of the first protrusion portion 24A and a trough line B of a floor portion of the first recess portion 24B. The outer side portion 26 is formed to continue from the first joining portion 24.

The above-described inner side flange portion 14B of the rail inner panel 14, inner side flange portion 16B of the rail outer reinforcement 16 and inner side flange portion 18B of the side outer panel 18—the three plates—are superposed and joined by spot welding. Similarly, the outer side flange portion 14C of the rail inner panel 14, outer side flange portion 16C of the rail outer reinforcement 16 and outer side flange portion 18C of the side outer panel 18—the three plates—are superposed and joined by spot welding. Thus, a vehicle framework member along the vehicle front and rear direction is formed at the roof side rail portion 12.

The roof panel 30 is provided with a roof main body portion 32 that is formed in a gently curved shape that protrudes to the vehicle upward side. The roof main body portion 32 covers the cabin from the vehicle upward side thereof. The inflected end portion 34 is formed at each of two vehicle width direction end portions of the roof panel 30. Each inflected end portion 34 is inflected to the vehicle downward side. The inflected end portion 34 is arranged so as to oppose the diagonal wall 20 of the side outer panel 18. The roof panel 30 is fabricated of aluminium.

As shown in FIG. 3, a seal wall portion 44, a seal shelf portion 42, a second joining portion 40, a foldback portion 38 and a distal end portion 36 are formed at the inflected end portion 34 in this order from the side thereof at which the roof main body portion 32 is disposed. The seal wall portion 44 is inflected to the vehicle cabin inner side from a vehicle width direction outer side end portion of the roof main body portion 32. The seal shelf portion 42 is inflected to the vehicle width direction outer side from a lower end of the seal wall portion 44. The seal shelf portion 42 is formed to be co-planar with an outer surface of the braze 50 that is described below. The meaning of the term “co-planar” as used herein does not necessarily require that an upper face of the seal shelf portion 42 and the outer surface of the braze 50 are completely in the same plane but encompasses structures that include steps of some size but that can be judged as being substantially co-planar.

The second joining portion 40 refers to a region that is brazed with the braze 50 that is described below, from the contact point T to a region corresponding with the upper end of the braze 50. The foldback portion 38 is an inflected portion that is folded back to the inner side (the vehicle cabin side) in the vehicle width direction from the contact point T. The distal end portion 36 refers to a portion from the foldback portion 38 to a distal end of the inflected end portion 34.

A recess portion 48 is formed between the first joining portion 24 and the second joining portion 40. The braze 50 is filled into the recess portion 48. In the present exemplary embodiment, the braze 50 is an aluminium braze whose principal component is aluminium. Therefore, the braze 50 is a metal that is homogenous with the roof panel 30 but heterogenous from the side outer panel 18. The braze 50 flows in between the first joining portion 24 and the second joining portion 40 in a molten state caused by laser brazing, and adheres to the first joining portion 24 formed with the first shelf portion 24C and the second joining portion 40. Thus, the first joining portion 24 and second joining portion 40 are joined via the braze 50. An outer face of the braze 50 is formed to be substantially co-planar with the seal shelf portion 42.

The sealing material layer 52 is layered onto an outer side of the braze 50. The sealing material layer 52 covers an outer surface of the braze 50 and is also layered onto the upper portion of the seal shelf portion 42. The outer face of the sealing material layer 52 is substantially co-planar with an upper face of the roof main body portion 32, forming a flat surface from the vehicle width direction end portion of the roof main body portion 32 to the outer side portion 26.

Now, operation and effects of the present exemplary embodiment are described. When the roof panel 30 and the roof side rail portion 12 are to be joined, the roof panel 30 is disposed at the upper portion of a body that includes the roof side rail portion 12. At this time, the roof panel 30 gains access to the body from the upper side and is disposed such that each inflected end portion 34 opposes the diagonal wall 20. The braze 50 is heated and melted by laser brazing. The braze 50 flows in between the first joining portion 24 and the second joining portion 40, filling the recess portion 48, and hardens. The outer face of the braze 50 is formed to be substantially co-planar with the seal shelf portion 42. The braze 50 adheres to the first joining portion 24 and the second joining portion 40. Thus, the first joining portion 24 and second joining portion 40 are joined via the braze 50.

Subsequently, the sealing material layer 52 is formed on the braze 50 and the upper side of the seal shelf portion 42. The sealing material layer 52 is formed to be substantially co-planar with the upper face of the roof main body portion 32. The sealing material layer 52 is leveled to be uniform from the vehicle width direction end portion of the roof main body portion 32 to the outer side portion 26, forming a flat surface.

The side outer panel 18 of the present exemplary embodiment is fabricated of steel plate, and intermetallic compounds are produced between the steel plate and the aluminium braze. However, the first protrusion portion 24A and the first recess portion 24B are formed at the first joining portion 24, and the first shelf portion 24C is formed between the first protrusion portion 24A and the first recess portion 24B. Therefore, a contact area between the first joining portion 24 and the braze 50 is expanded, and even though the brazing is implemented with the braze 50 that is an aluminium braze, joining strength with the steel plate may be assured.

In the present exemplary embodiment, the seal shelf portion 42 is formed in line with the outer surface of the braze 50. Therefore, the sealing material layer 52 layered on the braze 50 may also be formed at the outer side of the seal shelf portion 42. Although irregularities tend to occur at the outer surface of the braze 50, irregularities of the braze 50 may be covered over by the braze 50 being covered with the sealing material layer 52. Here, because the seal shelf portion 42 is employed, the thickness of the sealing material layer 52 is easily controlled, and the sealing material layer 52 at the outer surface may easily be formed with a suitable thickness.

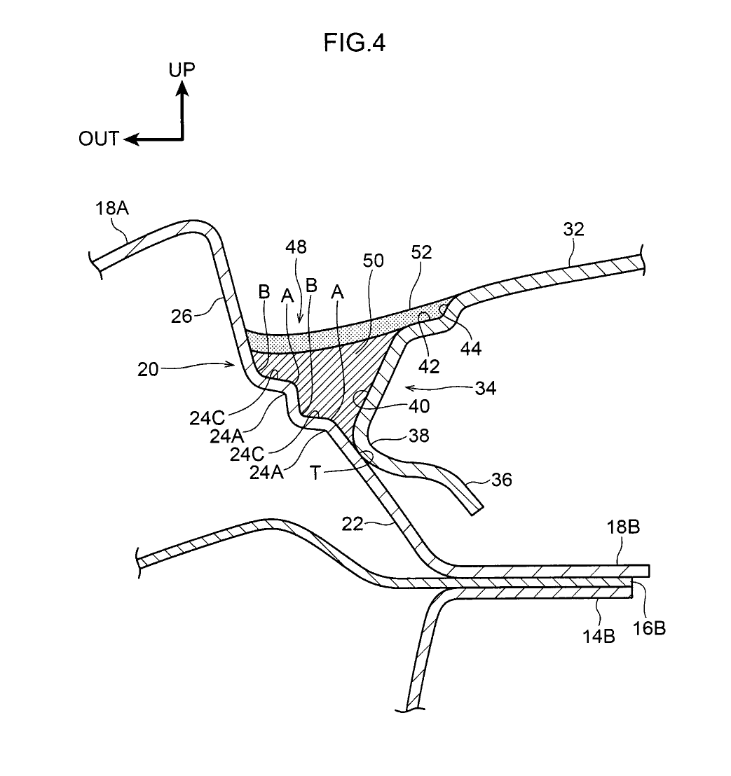

In the present exemplary embodiment, one set of unevenness shapes (the first protrusion portion 24A and first recess portion 24B) is formed at the first joining portion 24, and a single shelf portion (the first shelf portion 24C) is formed between the unevenness shapes. However, as illustrated in FIG. 4, two sets of unevenness shapes (two sets of the first protrusion portion 24A and first recess portion 24B) may be formed at the first joining portion 24 and two of the first shelf portion 24C may be formed.

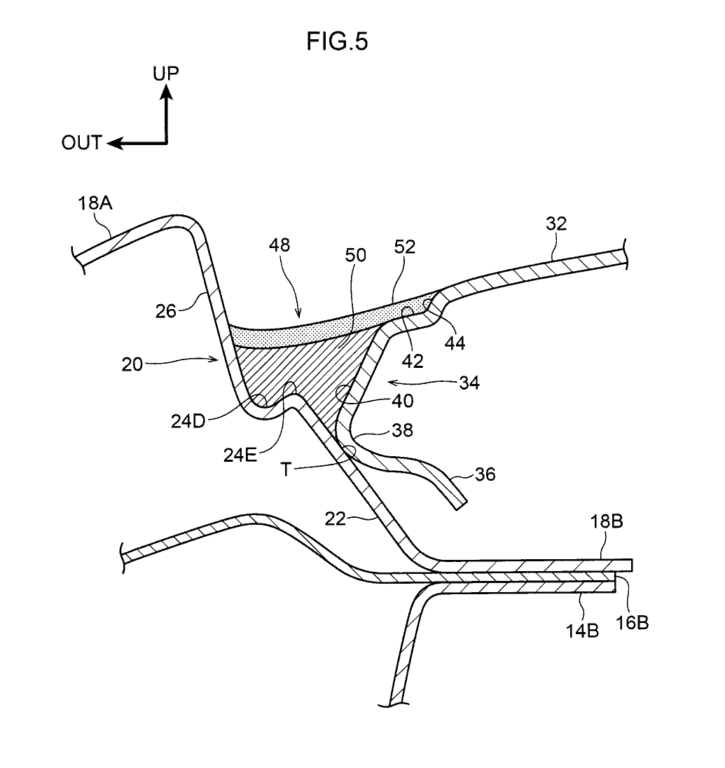

Further, in the present exemplary embodiment, the first shelf portion 24C is formed at the first joining portion 24. However, as illustrated in FIG. 5, a trough portion 24D and a ridge portion 24E in which a height difference of the unevenness is larger may be formed instead of the first shelf portion 24C.

### Second Exemplary Embodiment

Now, a second exemplary embodiment of the panel joining structure for a vehicle according to the present invention is described. In the present exemplary embodiment, the panel joining structure for a vehicle according to the present invention is described using an example in which the panel joining structure for a vehicle is applied to a vehicle roof 60. Portions that are similar to the first exemplary embodiment are illustrated with the same reference numerals applied and detailed descriptions thereof are not given.

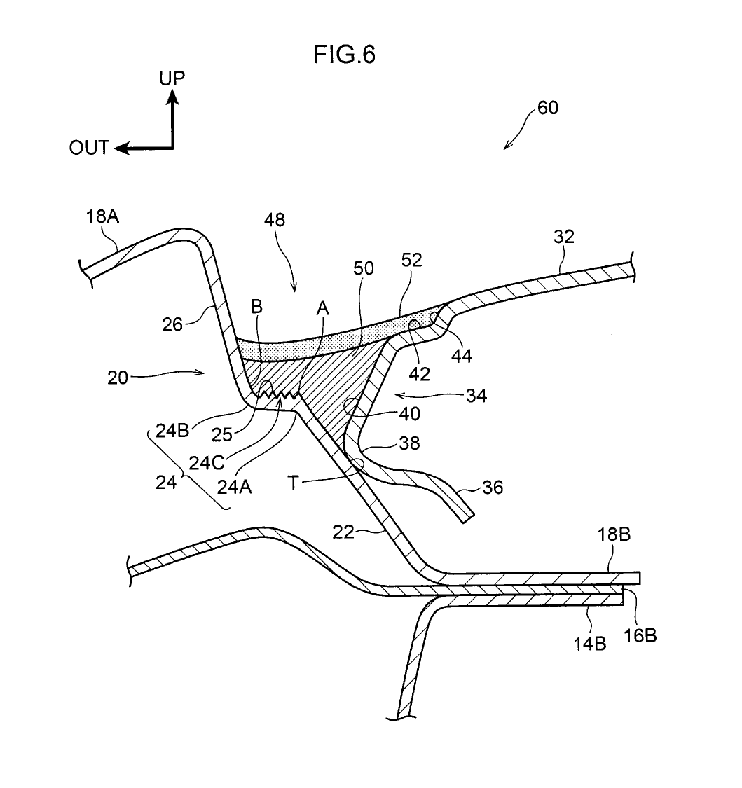

In the vehicle roof 60 according to the present exemplary embodiment, the shape of the first joining portion 24 is different from the first exemplary embodiment. Other structures are the same as in the first exemplary embodiment. As shown in FIG. 6, tiny unevennesses 25 are formed at the first shelf portion 24C of the first joining portion 24. The unevennesses 25 may be formed by a roughening treatment of the surface of the first shelf portion 24C, or edging or the like.

In the present exemplary embodiment, the braze 50 and the sealing material layer 52 may be formed in the recess portion 48 by the same procedure as in the first exemplary embodiment.

In the present exemplary embodiment, because the unevennesses 25 are formed at the first shelf portion 24C of the first joining portion 24, the contact area between the braze 50 and the first joining portion 24 is further enlarged, and joining strength of the braze 50 and the first joining portion 24 may be assured.

In the present exemplary embodiment, the unevennesses 25 are formed at the first shelf portion 24C. However, the unevennesses 25 may be formed at other locations of the first joining portion 24. For example, the unevennesses 25 may be formed at the side at which the inner side portion 22 is disposed relative to the first shelf portion 24C, or may be formed at the side at which the outer side portion 26 is disposed relative to the first shelf portion 24C. Furthermore, the unevennesses 25 that may assure joining strength may be formed over the whole of the first joining portion 24.

The unevennesses 25 of the present exemplary embodiment may be formed at the first joining portions 24 according to the variant examples of the first exemplary embodiment that are illustrated in FIG. 4 and FIG. 5.

### Third Exemplary Embodiment

Now, a third exemplary embodiment of the panel joining structure for a vehicle according to the present invention is described. In the present exemplary embodiment, the panel joining structure for a vehicle according to the present invention is described using an example in which the panel joining structure for a vehicle is applied to a vehicle roof 62. Portions that are similar to the first and second exemplary embodiments are illustrated with the same reference numerals applied and detailed descriptions thereof are not given.

In the vehicle roof 62 according to the present exemplary embodiment, the shape of the second joining portion 40 is different from the first exemplary embodiment. The present exemplary embodiment also differs from the first exemplary embodiment in that the braze is a metal that is heterogenous from the roof panel 30 and the side outer panel 18. Other structures are the same as in the first exemplary embodiment.

A second protrusion portion 40A and a second recess portion 40B are formed at the second joining portion 40. The second protrusion portion 40A is curved so as to protrude to the vehicle outer side, and the second recess portion 40B is curved to the vehicle outer side so as to form a recess. A second shelf portion 40C is formed between a ridge line C of a peak portion of the second protrusion portion 40A and a trough line D of a floor portion of the second recess portion 40B.

A recess portion 49 is formed between the first joining portion 24 and the second joining portion 40. The recess portion 49 is filled with a braze 70. In the present exemplary embodiment, the braze 70 is a zinc braze whose principal component is zinc. The braze 70 flows in between the first joining portion 24 and the second joining portion 40 in a molten state caused by laser brazing, and adheres to the first joining portion 24 at which the first shelf portion 24C is formed and the second joining portion 40 at which the second shelf portion 40C is formed. Thus, the first joining portion 24 and second joining portion 40 are joined via the braze 70. An outer face of the braze 70 is formed to be substantially co-planar with the seal shelf portion 42.

The sealing material layer 52 is layered onto an outer side of the braze 70. The sealing material layer 52 covers an outer surface of the braze 70 and is also layered onto the upper portion of the seal shelf portion 42. The outer face of the sealing material layer 52 is substantially co-planar with the upper face of the roof main body portion 32, forming a flat surface from the vehicle width direction end portion of the roof main body portion 32 to the outer side portion 26.

In the present exemplary embodiment too, the braze 70 and the sealing material layer 52 may be formed in the recess portion 49 by the same procedure as in the first exemplary embodiment.

In the present exemplary embodiment, the first shelf portion 24C and the second shelf portion 40C are formed at the first joining portion 24 and the second joining portion 40, respectively, expanding contact areas between the braze 70 and the first joining portion 24 and second joining portion 40. Therefore, even though the join between the roof panel 30 and the side outer panel 18 is implemented with the braze 70 that is heterogenous from both the roof panel 30 and the side outer panel 18, joining strengths of the braze 70 with the first joining portion 24 and the second joining portion 40 may be assured.

The second joining portion 40 according to the present exemplary embodiment may be combined with the first joining portions 24 according to the variant examples of the first exemplary embodiment that are illustrated in FIG. 4 and FIG. 5. Furthermore, the unevennesses 25 according to the second exemplary embodiment may be formed at the first joining portion 24 and the second joining portion 40 according to the present exemplary embodiment.

In the present exemplary embodiment, an example is described in which a zinc braze is used. However, brazes whose principal components are alternative materials may be used, such as, for example, a copper braze whose principal component is copper.

In the first to third exemplary embodiments described above, the panel joining structure for a vehicle relating to the present invention is applied to a vehicle roof. However, the panel joining structure for a vehicle relating to the present invention may be applied to alternative portions. For example, the panel joining structure for a vehicle may be applied to portions at which heterogenous metal panels are joined together at side panels, trunk lids and hoods of vehicles.

What is claimed is:

1. A panel joining structure for a vehicle comprising:
a first plate that is formed of a metal, at which a first joining portion is formed;
a second plate that is formed of a different metal from the first plate, a second joining portion that is to be joined with the first joining portion being formed at the second plate;
a braze that is interposed between the first joining portion and the second joining portion, the braze joining the first joining portion with the second joining portion; and
a surface area enlargement portion in a range that makes contact with the braze at, of the first joining portion and the second joining portion, a side at which the braze and a heterogenous metal are disposed, at least one of protrusions and recesses being formed at the surface area enlargement portion.

2. The panel joining structure for a vehicle according to claim 1, wherein unevenness is formed at the surface area enlargement portion by a shelf portion that is formed in a step shape.

3. The panel joining structure for a vehicle according to claim 2, wherein second unevennesses are formed at a surface of the shelf portion that makes contact with the braze.

4. The panel joining structure for a vehicle according to claim 1, wherein the first plate is a steel plate and the second plate is an aluminium plate.

5. The panel joining structure for a vehicle according to claim 1, further comprising:
a seal shelf portion structured by a portion of one of the first plate or the second plate, the seal shelf portion extending from the first joining portion or the second joining portion in line with an outer surface of the braze; and
a sealing material layer that is layered onto the braze and an outer side of the seal shelf portion, the sealing material layer being layered between the first joining portion and the second joining portion.
